(19) United States
(12) Patent Application Publication
(10) Pub. No.: US 2009/0266442 A1
(43) Pub. Date: Oct. 29, 2009

(54) Device for determining a fill level of a liquid container of an appliance, particularly a domestic appliance, and fill level sensor and detector circuit therefor

(75) Inventors: Christian Duscher, Undorf (DE); Bernhard Kobl, Regensburg (DE)

Correspondence Address: LERNER GREENBERG STEMER LLP, P O BOX 2480, HOLLYWOOD, FL, 33022-2480, US

(73) Assignee: BSH BOSCH UND SIEMENS HAUSGERÄTE GMBH, Munich (DE)

(21) Appl. No.: 12/097,676

(22) PCT Filed: Nov. 28, 2006
(86) PCT No.: PCT/EP06/68997

§ 371 Date: Oct. 8, 2008

(30) Foreign Application Priority Data
Dec. 16, 2005 (DE) 102005060363.7

(51) Int. Cl. B65B 3/26; G01F 23/24

(52) U.S. Cl. 141/95; 141/198; 73/304 R

(57) ABSTRACT

In order to determine a level, especially a safety level of a liquid container of an appliance operating with or processing a liquid, particularly a household appliance, a detector circuit is connected to a liquid level sensor array and emits a warning signal when the respective liquid reaches or exceeds a certain defined level in the liquid container accommodating the same. The aim is achieved by the fact that the liquid level sensor array contains at least one liquid level sensor which is provided with an electrically conducting contact part that is disposed in an isolated manner and encompasses an area which is uncovered or exposed for contacting the liquid only at the height of the defined level while the contact part is connected to a signal input of the detector circuit whose reference potential input associated with the corresponding signal input is connected to the liquid.

The present invention relates to a device for determining a defined fill level, in particular a defined safety fill level, of a liquid container of an appliance employing or processing a liquid, in particular a domestic appliance, by means of a detector circuit connected to a liquid fill level sensor arrangement and capable of producing an indication signal if a particular defined fill level is reached or exceeded by the liquid in question in the liquid container holding it.

The present invention also relates to a liquid fill level sensor for a device of the abovementioned type and to a detector circuit which can be connected to such a liquid fill level sensor.

To determine the fill level of a container to be filled with a liquid, fill level sensors employing different principles and devices incorporating them are well known. For example, a fill level sensor is known (DE 196 43 753 C1) which contains at least one float which can be acted upon by the liquid in a liquid container and by means of which a force can be applied in a contacting manner to the free end of a force gage. Between the force gage in question and the float a compensating rod is disposed with one end pivotally mounted and a compensating weight suspended from the opposite end. The unilaterally fixed force gage is constituted by a resistance sensor, a piezo transducer, a spring deflection measuring system or by a flexural element. However, this known fill level sensor is of relatively complex design.

Also known in connection with electrically operated domestic appliances are fill level sensors employing pressure transducers (DE 198 35 865 C2; DE 199 08 804 A1, DE 199 20 870 C2). With said known fill level sensors, either normal mechanical load cells or flow meters or more specifically dynamic pressure gages are used to determine liquid fill levels in liquid containers. The design complexity involved is likewise relatively high.

Also already known are fill level sensors for determining the liquid fill level of liquid containers (DE 101 35 191 A1, DE 102 01 767 A1), comprising a light transmitting element, in particular in the form of an LED, and an opto-receiver, particularly in the form of a photodiode, and in which the opto-transmitter and receiver are disposed outside the liquid container at opposite locations corresponding to the liquid level to be determined and therefore the fill level within the liquid container in question. However, the operation of such fill level sensors requires an appropriately designed optical connection path between the respective opto-transmitter and receiver through the liquid container in question. This, however, involves considerable design complexity which is generally regarded as undesirable.

A laundering appliance such as a washing machine, a tumble dryer or a dryer with an electrically conducting liquid container in the form of a washing liquor container and/or a laundry drum is also already known (DE 43 04 009 C2), wherein the electrical resistance or some other electrical property of the liquid in the liquid container in question is measured by means of a liquid fill level sensor arrangement and evaluated in an evaluation circuit. In the case of the liquid container associated with an electric washing machine, a tumble dryer or a dryer, said liquid fill level sensor arrangement is electrically connected to said liquid container and to the conductive surface of a door, by means of which the liquid container in question can be sealed to the outside, said door consisting of a cup shaped inspection window which is provided with an electrically conducting coating of tin oxide, tin oxide with a metal alloy or an electrically conducting ceramic layer. The design complexity required is therefore relatively high. In addition, there is the risk that the operability of such a liquid fill level sensor arrangement will be impaired during operation by the liquids used in said appliance container.

Finally, there is also already known a water safety device for a domestic appliance, namely for a dishwasher or washing machine (DE 195 28 322 C2) having a working liquid container to which a working liquid can be fed. The known water safety device in question comprises a collecting tray at the base of the appliance into which the working liquid can be discharged after an overflow in the working liquid container without interrupting the water feed, there being provided a fill level sensor which determines the filling of the working liquid container with working liquid during a time at which such filling is not intended, and control electronics for program control of the dishwasher or washing machine. A drain pump can be activated by the control electronics if impermissible filling is detected at this time. Using said fill level sensor which has two electrodes spaced apart from one another, the conductivity of the working liquid between said electrodes is measured. The two electrodes are effectively embodied as pin electrodes which are disposed at different heights in said working liquid container. The liquid fill level sensor arrangement therefore involves a relatively high degree of complexity in this case also.

For all the known liquid fill level sensor arrangements considered above, insofar as their construction is discernible, a degree of design complexity is required which is often regarded as excessively high. This applies particularly to the case where such a liquid fill level sensor arrangement is to be used to determine a safety fill level of a liquid container. The term safety fill level is to be understood here as meaning a liquid fill level above a normal fill level of the relevant liquid container and which must not be exceeded under any circumstances. In the event of such a safety fill level being exceeded, there would be a risk of the liquid contained in the relevant liquid container being able to escape therefrom, even in the case of a liquid container sealed by a door, e.g. through feed ports normally associated with the relevant liquid container.

The object of the invention is therefore to show a way of determining a liquid fill level and in particular a safety fill level of a liquid container of an appliance, in particular a domestic appliance, having particularly low design complexity, and also of enabling liquid fill level signals to be effectively generated and evaluated.

This object is inventively achieved for a device mentioned in the introduction by incorporating in the liquid fill level sensor arrangement at least one liquid fill level sensor which has an electrically conducting contact section disposed in an insulated manner and with an uncovered or exposed area only at the height of said defined fill level for contacting said liquid, and by connecting said contact section to a signal input of the detector circuit whose reference potential input associated with the signal input in question is in contact with said liquid.

This confers the advantage of particularly low complexity for determining a defined fill level and in particular a defined safety fill level of a liquid container of an appliance and in particular a domestic appliance which can be e.g. a washing machine or a dishwasher. The liquid fill level sensor used according to the invention—two liquid fill level sensors are provided if necessary—can be constituted, for example, by a generally insulated sheet metal part, e.g. of stainless steel, which is uncovered or exposed only at the height of said defined fill level, which can be in particular a defined safety fill level, for contacting said liquid, i.e. allows an electrically conducting connection to be established in this area to the liquid present there. Moreover, the arrangement of said liquid fill level sensor is particularly simple. Said generally insulated electrically conducting contact section can, as will be made clearer further below, be simply hung from the rim of the liquid container in which the fill level is to be monitored and therefore determined.

The indication signal that can be produced by the abovementioned detector circuit can preferably be used for regulating the liquid fill level in the liquid container, thereby advantageously enabling any overflowing of the liquid container in question by the liquid contained therein to be avoided.

The liquid feed to the liquid container in question is advantageously stoppable, i.e. the liquid feed can be shut off, and/or the liquid can be drained from the liquid container in question.

Said fill level sensor is advantageously disposed in the vicinity of a device door by means of which the liquid container can be sealed to the outside. The advantage of this is that reliable fill level detection is ensured even if the liquid container and therefore the appliance containing same is tilted in the direction of the device door. If the liquid container is tilted toward other sides of the device incorporating the liquid container, i.e. its left, right and rear sides, no problems generally arise, as the liquid container in question is only open to the front of the appliance on which the appliance door is provided.

The liquid fill level sensor is preferably located in a central area of said liquid container.

According to the present invention there is additionally created a liquid fill level sensor for a device for detecting a defined fill level, in particular a defined safety fill level, of a liquid container of an appliance employing or processing a liquid, in particular a domestic appliance. Said liquid fill level sensor is characterized in that it has an electrically conducting contact section disposed in an insulated manner with an uncovered or exposed area only at the height of said defined fill level for contacting said liquid and to which can be connected a signal input of a detector circuit which can be connected to said liquid by a reference potential input associated with the signal input in question. Such a design of the liquid fill level sensor allows reliable determination of a fill level, in particular a safety fill level, of a liquid container, with particularly low design complexity.

To determine and evaluate liquid fill level signals which can be produced by a liquid fill level sensor particularly in accordance with the abovementioned type, a detector circuit containing a semiconductor circuit connected to a DC supply voltage source is used which is connectable by a signal input to the liquid fill level sensor and by a reference potential input to the liquid whose fill level in a liquid container holding it is ascertainable by means of the liquid fill level sensor, and which only activates a conductive current path via which signals can be fed for evaluation from an AC voltage source connected to the semiconductor circuit in question or produced as indication signals when the uncovered or exposed electrically conducting contact section of the fill level sensor is contacted by said liquid. This means that the particularly reliably operating detector circuit according to the invention is characterized by low complexity.

The AC voltage source is preferably a square wave signal source connected in series with the DC supply voltage source. This advantage of this is that the detector circuit is particularly simple to implement and safe to operate.

Said semiconductor circuit advantageously contains a single bipolar transistor which can be connected on the base side to the known liquid fill level sensor and is connected on the emitter or collector side to the supply voltage source. This has the advantage of particularly low complexity for implementing the detector circuit according to the invention.

Said bipolar transistor is advantageously connected to the liquid fill level sensor via a capacitor arrangement, thereby ensuring particularly reliable operation of the detector circuit according to the invention in a relatively simple manner.

Said capacitor arrangement contains according to a development of the invention at least one high dielectric strength capacitor, a so-called Y2 capacitor. At least two such high dielectric strength capacitors connected in series can be used, or a component incorporating two series connected high dielectric strength capacitors, thereby ensuring reliable operation of the detector circuit according to the invention in a relatively simple manner taking voltage safety aspects into account.

In the collector or emitter circuit of said bipolar transistor there is preferably disposed a diode providing a path for the emitter-collector current or the collector-emitter current of said bipolar transistor, said diode being connected in series with an RC element across which a voltage which can be used as an indication signal or for producing an indication signal is dropped when the bipolar transistor is turned on. This ensures that the voltage across the capacitor of said RC element cannot be discharged again via said bipolar transistor, but is only discharged slowly via the preferably high value resistor of the RC element in question.

An ohmic resistor is advantageously inserted between the emitter or collector and the base of said bipolar transistor. This circuit arrangement enables the bipolar transistor in question to be turned on in a relatively simple manner by voltage signal components of one polarity of the voltage signals produced by the AC voltage source or square wave signal source, in order to produce thereby an analyzable signal via its then turned-on emitter-collector or collector-emitter junction.

The invention will now be explained in greater detail by way of example with reference to the accompanying drawings in which:

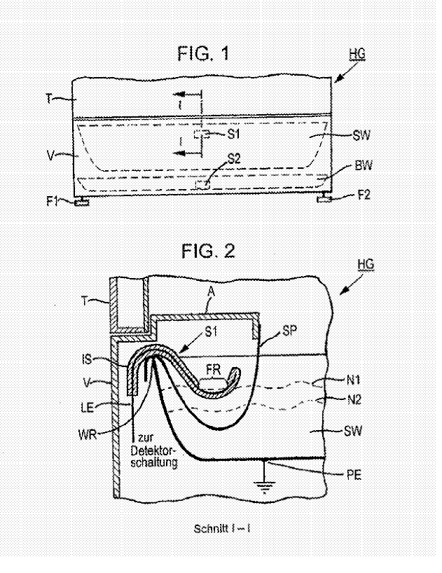

FIG. 1 shows a downsized front view of a detail of a domestic appliance to which the present invention is applied.

FIG. 2 shows a liquid fill level sensor according to an embodiment of the invention in an enlarged sectional view along the intersecting line I-I marked in FIG. 1.

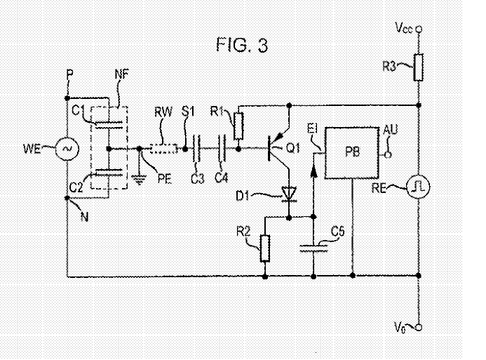

FIG. 3 schematically illustrates in a circuit diagram the design of an evaluation circuit with a detector circuit according to an embodiment of the invention.

FIG. 1 shows a downsized front view of a detail of a domestic appliance, in particular a domestic appliance HG, which employs or processes a liquid. The appliance or more specifically the domestic appliance HG can be, for example, a washing machine, a tumble dryer or a dishwasher. In the present case, the domestic appliance HG, a detail of which is shown in FIG. 1, shall be a dishwasher by way of example.

The upper part of FIG. 1 shows a door T of the domestic appliance HG, providing a liquid-tight seal for the working area contained in the domestic appliance HG. In the case of a washing machine or tumble dryer, said working area comprises a drum, and in the present case of a dishwasher, at least one dish rack.

In the area below the door T, the domestic appliance HG, a detail of which is shown in FIG. 1, has an area covered by a paneling section V in which a dishwasher sump SW is located which is used to hold a washing liquid which the dishwasher constituting here the domestic appliance HG employs to wash the dishes loaded therein. As indicated in FIG. 1, the dishwasher sump SW is tub-shaped.

Below the dishwasher sump SW there is disposed another receptacle, a so-called drip tray BW which is effectively used to provide protection against liquid overflowing the dishwasher sump SW.

On its underside the domestic appliance HG has mounting feet, of which two F1, F2 are indicated in FIG. 1. Generally four mounting feet are provided at all four corners of the domestic appliance HG in question.

In the central area of the dishwasher sump SW, more precisely in the upper region of said dishwasher sump SW, a liquid fill level sensor S1 is disposed inside the dishwasher sump SW. In principle a plurality of liquid fill level sensors can also be provided here, particularly at different heights. Another liquid fill level sensor S2 is disposed in the central area of the drip tray BW, more precisely on the base of said drip tray BW or in the vicinity thereof. It should be noted that the liquid fill level sensors S1, S2 in question are disposed inside the two receptacles SW, BW such that they face the front of the domestic appliance HG, i.e. the side of the appliance on which the door T is located. As already described above, this enables liquid levels in the two receptacles SW, BW to be reliably determined even when the domestic appliance HG is tilted forward to a critical extent, i.e. toward the door side. Alternatively it is also possible, to provide a selective overflow in the case of the dishwasher sump SW so that, when a predefined liquid level is present, liquid can drain away from the dishwasher sump SW into the drip tray BW. This enables the liquid fill level sensor S1 of the dishwasher sump SW to be dispensed with, as the overflowing liquid can be detected by the liquid fill level sensor S2 of the drip tray BW.

Of the two liquid fill level sensors S1 and S2 only shown schematically in FIG. 1, the liquid fill level sensor S1 is more clearly illustrated in enlarged detail in FIG. 2. This detail corresponds to a section I-I according to the intersecting lines I-I marked in FIG. 1. The door T and the paneling section V of the domestic appliance HG mentioned in connection with FIG. 1 are shown in part. Also depicted is the dishwasher sump SW which, like the drip tray BW shown in FIG. 1, may consist of an electrically conducting material, such as in particular stainless steel and which is connected at one point to protective ground PE. The drip tray BW can also be connected/is connected to protective ground PE. It should be noted at this juncture that in the event that the respective receptacle SW, BW or more precisely the liquid contained therein has no direct contact with protective ground PE, such a contact can be established by means of a separate electrode. However, it is also possible to provide two liquid fill level sensors in the respective receptacle SW, BW.

Around its rim WR, the dishwasher sump SW has an e.g. rubber or plastic anti-splash device SP which is attached to a cover A of the paneling section V by its end facing away from the rim WR. This ensures that movements occurring inside the dishwasher sump SW of a washing liquid contained in said dishwasher sump SW do not cause the liquid to splash over the rim WR.

On the rim WR of the dishwasher sump SW shown in FIG. 2 there is placed or mounted the liquid fill level sensor S1 shown schematically in FIG. 1. This is only depicted schematically in FIG. 2 in order to illustrate the principle of the present invention. The liquid fill level sensor S1 contains an electrically conducting contact section LE which is completely enclosed by an electrical insulation IS apart from an uncovered area FR. The uncovered or exposed area FR is in this case on the side of the contact section LE facing the top of the appliance. This ensures that the liquid fill level sensor S1 containing the contact section LE detects the liquid fill level N1 only when it is washed by liquid in its region FR at the height of said level N1. Liquid splashes which occur before this level N1 is attained by the liquid present in the dishwasher sump SP and presumably rising in level and which are directed toward the contact section LE do not therefore cause erroneous level detection.

As shown in FIG. 2, the electrically conducting contact section LE together with its insulation IS is here appropriately bent in the form of a reversed letter S such that its uncovered or exposed area FR is in the vicinity of the liquid fill level N1 inside the dishwasher sump SW. Said liquid level N1 is in this case in particular a safety fill level which, if reached or exceeded, necessitates particular safety action in the domestic appliance HG, such as shutting off a liquid supply to the domestic appliance HG and/or causing liquid to be drained from the domestic appliance HG in question.

FIG. 2 shows another liquid fill level N2 below the liquid fill level N1. This liquid fill level N2 may be e.g. the liquid fill level for normal operation of the domestic appliance HG. Said liquid fill level N2 can basically be determined or monitored using a liquid fill level sensor corresponding completely to the liquid fill level sensor S1. However, it is also possible to use any other known liquid fill level sensor for this task.

Having regard to the liquid fill level sensor S1 as shown in greater detail in FIG. 2, it should also be noted that its electrically conducting contact section LE can consist e.g. of a sheet metal part a few centimeters (e.g. 1 to 10 cm) wide which is made of metal, such as in particular stainless steel. Alternatively, however, the sheet metal part can also extend over the entire width of the dishwasher sump SW indicated in FIG. 1. The insulation IS can be constituted by any insulating material that is resistant to the liquid with which the liquid fill level sensor S1 in the domestic appliance HG in question may come into contact.

As indicated in FIG. 2, the electrically conducting contact section LE of the liquid fill level sensor S1 leads to a detector circuit (not shown in FIG. 2). The liquid fill level sensor S2 indicated in FIG. 1 and possibly still other liquid fill level sensors provided can incidentally also be connected to said detector circuit. The detector circuit in question or rather an evaluation circuit containing same can be either mounted directly on the liquid fill level sensor S1 or S2 or electrically connected thereto. In addition, it is also possible to incorporate the liquid fill level sensor S2 including detector circuit into power electronics (not shown) of the domestic appliance HG in question.

The circuit diagram in FIG. 3 schematically illustrates the design of an evaluation circuit embodying the abovementioned detector circuit. Before describing this detector circuit in greater detail, the basic circuitry of FIG. 3 will first be considered.

In the left-hand section of the circuit diagram in FIG. 3 an AC voltage source WE is indicated which can be an AC line voltage source delivering e.g. 230 VACrms at 50 Hz. The AC voltage source WE can alternatively be a power supply device providing an AC voltage derived from the AC line voltage for operating the domestic appliance HG containing the circuitry in question. In the case of an AC line voltage source WE, the latter has, as indicated in FIG. 3, a phase conductor P and a neutral conductor N. To these two conductors P, N is connected, as shown in FIG. 3, a line filter NF comprising two series connected capacitors C1 and C2. Said capacitors C1, C2 are preferably so-called Y2 capacitors, i.e. high dielectric strength capacitors (withstand voltage >5000 V), which ensure a particular degree of safety in the line filter NF and therefore in the entire appliance or more specifically domestic appliance. The common connection point of the two capacitors C1 and C2 of the line filter NF is in this case connected to protective ground PE of the domestic appliance HG.

The abovementioned detector circuit, an embodiment of which is shown in FIG. 3, will now be examined in greater detail. The detector circuit in question contains a semiconductor circuit which is formed here by a single pnp-type bipolar transistor Q1. Said transistor Q1 is connected by its emitter via an ohmic resistance R3 to the positive terminal V_{CC} of a DC supply voltage source not shown in greater detail here. The transistor Q1 is connected by its collector to the negative terminal V₀ of said DC supply voltage source via the series circuit consisting of a diode D1 biased in the conducting direction for a current flow across the emitter-collector junction of the transistor Q1 and a thereto connected parallel RC element comprising an ohmic resistor R2 and a capacitor C5. The negative terminal V₀ of said DC supply voltage is incidentally connected to the neutral conductor N of the already mentioned AC voltage source WE.

The base of the transistor Q1 is connected via an ohmic resistor R1 to the emitter of said transistor Q1. The base of the transistor Q1 is connected to the liquid fill level sensor S1, only indicated as a circuit node in FIG. 3, via a capacitor arrangement which in the present case comprises two series connected capacitors C3 and C4. Said capacitors C3 and C4 are likewise Y2 capacitors, i.e. high dielectric strength capacitors which are particularly reliable. These two capacitors C3, C4 can possess capacitances of e.g. 2.7 nF and 27 nF respectively. Although a single capacitor will basically suffice here, the two capacitors C3 and C4 are provided as a series circuit for safety reasons: should for any reason one of these capacitors C3, C4 break down, the circuitry in question will nevertheless remain operational using the capacitor that is still intact. It is also possible to employ a single component in which the two capacitors C3 and C4 are incorporated as a series circuit. With reference to the capacitors C3, C4 it should also be noted here that they act as a high pass filter for the 50 Hz AC voltage, thereby preventing any parasitic voltage from reaching the transistor Q1.

The liquid fill level sensor S1 indicated as a circuit node in FIG. 3 is connected to protective ground PE via a resistance RW indicated by a dashed line—also termed liquid resistance. This electrical connection is established when the relevant liquid fill level sensor S1 in the domestic appliance HG as shown in FIGS. 1 and 2 is covered and/or washed by liquid. Depending on the composition of the liquid in question, said resistance RW has an ohmic component in the order of a few ohms to a few hundred ohms.

An AC voltage source, which in the present case is a square wave voltage source RE, which produces square wave pulses with a frequency of e.g. 1 kHz and 20 kHz, is connected in the present case between the emitter of the transistor Q1 and the ohmic resistor R3 on the one hand and the negative terminal V₀ of the abovementioned DC supply voltage source on the other. The AC voltage source in question and the abovementioned DC supply voltage source are therefore electrically connected in series. By means of the AC voltage or rather the square wave pulses thus provided, as will become clear, a resistance or rather conductance measurement (RW) effectively takes place in the event of the liquid fill level sensor S1 being washed by liquid.

A level evaluation circuit PB is connected by its input EI to the common connection point of the diode D1 and the parallel RC element comprising the ohmic resistor R2 and the capacitor C5. The level evaluation circuit PB is connected by its reference signal input (not specifically identified) to the negative terminal V₀ of the abovementioned DC voltage supply source. From an output pin AU, the level evaluation circuit PB is able to feed out indication signals in the event of the liquid fill level sensor S1 indicating the presence of a liquid. The level evaluation circuit PB in question can be constituted e.g. by a microcontroller with input-side A/D converter. Said microcontroller can incidentally assume the task of the abovementioned square wave signal source RE by delivering square wave pulses.

Now that the design of the circuitry shown in FIG. 3 has been sufficiently explained for an understanding of the present invention, the mode of operation of said circuitry will now be described in detail.

In the idle state, i.e. when the liquid fill level sensor S1 detects no liquid, the transistor Q1 is turned off by the positive potential applied by the positive terminal V_{CC} of the DC supply voltage source to its base. The square wave pulses provided by the square wave signal source RE are likewise unable to turn on the transistor Q1, as no current path for these square wave pulses exists at this time. The negative potential from the negative terminal or pin V₀ of the DC supply voltage source is therefore present at the common connection point of the diode D1 and the RC element comprising the ohmic resistor R2 and the capacitor C5. In this case the level evaluation circuit PB produces no indication signal at the output pin AU.

If the liquid fill level sensor S1 now detects the presence of a liquid in the dishwasher sump SW containing said sensor as shown in FIGS. 1 and 2, so that a relatively low-value liquid resistance RW is present between said liquid fill level sensor S1 and protective ground PE, a square wave pulse current flows from the square wave signal source RE via the ohmic resistor R1, the two capacitors C4, C3, the liquid resistance RW to be regarded as water resistance and the capacitor C2 of the line filter NF, the positive pulse components of the square wave pulses in question causing a voltage to dropped across the resistor R1 such that a lower potential is present at the base of the transistor Q1 than at its emitter. In the event of a sufficiently high potential difference between base and emitter, the transistor Q1 is thus turned on, with the result that current flows via its collector-emitter junction and the circuit comprising the diode D1 and the abovementioned RC element R2, C5, said circuit being connected in series with the collector of the transistor Q1 in question. This current flow causes a voltage to be dropped across the capacitor C5 of the RC element in question. This voltage is then evaluated by means of the level evaluation circuit PB, whereupon the latter now produces an indication signal at its output pin AU. Said indication signal can, as described above, be used to shut off the liquid supply to the domestic appliance HG with which the circuitry in question in associated, and/or to cause said domestic appliance to be drained of liquid. However, it is also possible, additionally thereto or independently thereof, to produce a visual and/or audible indication signal in order to prompt a user to instigate appropriate safety measures.

In the circuit arrangement considered above as shown in FIG. 3, the diode D1 is used to prevent the capacitor C5 from discharging via the collector-base junction of the then turned-off transistor Q1 and the ohmic resistor R1 in the event of the occurrence of the negative pulse components of the square wave signal produced by the square wave signal source RE. The ohmic resistor R2, which is relatively high-value, is used to slowly discharge the capacitor C5 if the liquid fill level sensor S1 loses contact with the liquid and the transistor Q1 is therefore turned off, thereby returning the circuit arrangement to its initial state.

Finally it should be noted that the detector circuit shown in FIG. 3 can also be implemented in another way. For example, the bipolar transistor Q1 can be replaced e.g. by an npn-type bipolar transistor. In this case the polarity of the DC supply voltage and the poling of the diode D1 must be appropriately matched to the changed conditions. In each case the semiconductor or more specifically bipolar transistor is turned in an alternating current manner by the positive or negative pulse components resulting from the square wave pulses produced by the square wave signal source RE at the common connection point of the ohmic resistor R1 and the capacitor arrangement comprising the capacitors C3, C4 if the liquid fill level sensor S1 has detected a liquid and an electrically conducting connection is established via the liquid resistance RW.

### REFERENCE CHARACTER LIST

A cover
AU output pin
BW drip tray
C1, C2, C3, C4, C5 capacitors
D1 diode
EI input pin
F1, F2 mounting feet
FR exposed area
HG domestic appliance
IS insulation
LE contact section
N neutral conductor
N1 liquid fill level
N2 liquid fill level
NF line filter
P phase conductor
PB level evaluation circuit
PE protective ground
Q1 bipolar transistor
R1, R2, R3 ohmic resistors
RE square wave signal source
RW liquid resistance
S1, S2 liquid fill level sensors
SP anti-splash device
SW dishwasher sump
T door
V paneling section
V₀ negative terminal of DC supply voltage source
V_{CC} positive terminal of DC supply voltage source
WE AC voltage source
WR rim of dishwasher sump

1-14. (canceled)

15. A device for determining a defined fill level, including a defined safety fill level, of a liquid container of an appliance one of employing a liquid and processing the liquid, the device comprising:
a liquid fill level sensor configuration connected to the liquid container and having an electrode accommodated in the liquid container and coming into contact with the liquid when the liquid enters the liquid container, said electrode having an electrically conducting contact section disposed in an insulated manner with one of an uncovered area and an exposed area only at a height of the defined fill level for contacting the liquid;
a detector circuit connected to said liquid fill level sensor configuration and generating an indication signal if the defined fill level is one of reached and exceeded by the liquid in the liquid container, said detector circuit having a signal input and a reference potential input associated with said signal input; and
said electrically conducting contact section one of placed and mounted on a rim of the liquid container being connected to said signal input of said detector circuit, said reference potential input associated with said signal input being in contact with the liquid container.

16. The device according to claim 15, wherein the indication signal can be used for regulating a liquid fill level of the liquid container.

17. The device according to claim 16, wherein a liquid supply to the liquid container can be shut off.

18. The device according to claim 16, wherein the liquid can be drained from the liquid container.

19. The device according to claim 15, wherein said liquid fill level sensor configuration is disposed in a vicinity of an appliance door by which the liquid container can be sealed to an outside.

20. The device according to claim 19, wherein said liquid fill level sensor configuration is located in a central region of the liquid container.

21. The device according to claim 15, wherein said detector circuit contains a single bipolar transistor having a base connected to said fill level sensor configuration, an emitter and a collector, said emitter and collector connected to a series circuit formed of a supply voltage source connected in series with an AC voltage source, and the AC voltage source generating an AC voltage for producing the indication signal only if said bipolar transistor is turned on due to said electrically conducting contact section of said liquid fill level sensor configuration coming into contact with the liquid.

22. The device according to claim 15, wherein the appliance is a domestic appliance.

23. A liquid fill level sensor for a device for detecting a defined fill level, including a defined safety fill level, of a liquid container of an appliance one of employing a liquid and processing the liquid, by a detector circuit connected to a liquid fill level sensor configuration and capable of producing an indication signal if the defined fill level is one of reached and exceeded by the liquid in question in the liquid container holding the liquid, the liquid fill level sensor comprising:
an electrically conducting contact section disposed in an insulated manner with one of an uncovered area and an exposed area only at a height of the defined fill level for contacting the liquid, said area being one of placeable and mountable on a rim of the liquid container and connectable to a signal input of the detector circuit which can be connected by a reference potential input associated with the signal input to the liquid container.

24. A detector circuit for detecting and evaluating liquid fill level signals produced by a liquid fill level sensor, the detector circuit comprising:
a series circuit formed of an AC voltage source and a supply voltage source connected in series with said AC voltage source; and
a single bipolar transistor having a base connected to the liquid fill level sensor, an emitter and a collector, said emitter and said collector connected to said series circuit, said AC voltage source generating an AC voltage for producing an indication signal only if said single bipolar transistor is turned on due to an electrically conducting contact section of the liquid fill level sensor coming into contact with a liquid.

25. The detector circuit according to claim 24, wherein said AC voltage source is a square wave signal source connected in series with said supply voltage source being a DC supply voltage source.

26. The detector circuit according to claim 24, further comprising a capacitor configuration having a first side connected to said base of said single bipolar transistor and a second side connected to the liquid fill level sensor.

27. The detector circuit according to claim 26, wherein said capacitor configuration contains at least one high dielectric strength capacitor.

28. The detector circuit according to claim 24, further comprising:
a diode coupled to one of said collector and said emitter of said bipolar transistor, said diode providing a conducting path for one of an emitter-collector current and a collector-emitter current of said bipolar transistor; and
an RC element connected in series with said diode, a voltage dropping across said RC element when said bipolar transistor is turned on being used as one of the indication signal and for producing the indication signal.

29. The detector circuit according to claim 24, further comprising an ohmic resistor inserted between one of said emitter and said base and said collector and said base of said bipolar transistor.

30. The detector circuit according to claim 26, wherein said capacitor configuration contains at least two series connected high dielectric strength capacitors.
